(19) United States
(12) Patent Application Publication
(10) Pub. No.: US 2005/0074236 A1
(43) Pub. Date: Apr. 7, 2005

(54) Optical network monitoring system

(75) Inventors: Reddy Urimindi, Plano, TX (US); John Carberry, Talbott, TN (US); Michael L. Smith, Jefferson City, TN (US)

Correspondence Address: PITTS AND BRITTIAN P C, P O BOX 51295, KNOXVILLE, TN, 37950-1295, US

(73) Assignee: Neptec Optical Solutions, Inc., Jefferson City, TN (US)

(21) Appl. No.: 10/679,980

(22) Filed: Oct. 7, 2003

(51) Int. Cl. H04B 10/08

(52) U.S. Cl. 398/12

(57) ABSTRACT

A system for monitoring and managing optical networks. The system includes tapping a test signal from optical signals in the optical network, routing the test signals through a N×1 switch, to a 1×N switch, to a selected test device. A processor controls the switching and monitors the test results, and initiates corrective action as required. The corrective action includes grooming and rerouting signals in the optical network in response to a failure or risk of failure.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of Invention

This invention pertains to a system for monitoring and testing optical networks. More particularly, this invention pertains to an apparatus at the physical layer of an optical network that selects one of the numerous channels and routes the optical signal to various test equipment.

2. Description of the Related Art

Optical transmission systems, as characterized by SONET (Synchronous Optical Network), SDH (Synchronous Digital Hierarchy) and others, are managed, groomed, characterized, routed, protected, and restored by switching systems at layer one or two. Layer one, the physical layer, or optical layer, is typically treated as a passive system, and is created 100% redundant due to the need for “SONET level” dynamics, which are 10 msec at layer one and 50 msec at layer two.

There is a need for optical dynamics at layer one to free up these reserved resources, which would also aid to reduce operating expenses and capital expenses. The World's data traffic is growing at 100% per year while revenue per bit is dropping as much as 50% per year. Maximizing SONET reserved resources for data traffic while maintaining SONET level robustness is one of the few options available to the carriers to solve this dilemma.

Various devices exist for performing specific aspects of optical network control. Examples of such devices include U.S. Pat. No. 6,430,335, titled “Network Healing Smart Fiber Optic Switch,” issued to Carberry, et al., on Aug. 6, 2002, discloses a device that switches optical signals based upon degradation or complete failure of one signal. U.S. Pat. No. 5,726,788, titled “Dynamically Reconfigurable Optical Interface Device Using an Optically Switched Backplane,” issued to Fee, et al., on Mar. 10, 1998, discloses an apparatus for dynamically reconfiguring a telecommunications network when a failure occurs.

### BRIEF SUMMARY OF THE INVENTION

A system for monitoring and managing optical networks is provided. A processor controls an optical switch coupled to the physical layer of an optical network. The switch routes optical signals to selected test devices for monitoring and testing various optical parameters. The processor controls a routing switch that routes traffic in the network based on test results obtained by testing various optical parameters.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a one-line diagram of one embodiment of the apparatus;

FIG. 2 is a diagram of one embodiment of the optical connections from the couplers to the test devices; and

FIG. 3 is a flow diagram of one embodiment of the functions performed by the processor.

### DETAILED DESCRIPTION OF THE INVENTION

A system, generally shown as 10 on the figures, for monitoring and managing optical networks is disclosed. The system is configurable for both single mode and multimode functionality. The system, in various embodiments, performs one or more of the following functions within the physical layer of an optical network. First, the system optically monitors a large number of optical channels with a common control and testing system through the use of optical switches in an N×1 array, which combines many N×1 switch arrays through couplers.

Second, the system distributes the optically selected channel to an array of test equipment through an 1×N switch. Equipment to which the selected monitored channel is directed by this 1×N switch includes bit error measurement, spectrum analysis, chromatic dispersion, polarization mode dispersion measurement (PMD), power, reflection, and optical time domain reflectometer (OTDR) measurements, among others. The system provides alarms and messages and reroute traffic based upon previously established performance thresholds.

Third, the system manages the monitoring pattern both with regard to the pattern and schedule in which the various channels are monitored, including the pattern and schedule in which the selected channels are tested because, in select embodiments, the various tests are performed on discrete schedules and patterns.

Fourth, the system collects and characterizes the test data in real time, and provides real time historical test data in various reports. Fifth, the system provides alarm functions through network interfaces based on discrete or pattern programmed thresholds. Sixth, the system provides network healing functions. Seventh, the system provides grooming though the use of switches for protection, restoration, hot spare management, bandwidth management, etc. Eighth, the system provides the platform of awareness and dynamics that allows the use of SONET/SDH reserved and idle resources for transmission of traffic while still providing the basis of SONET required level of service on a majority of the physical network.

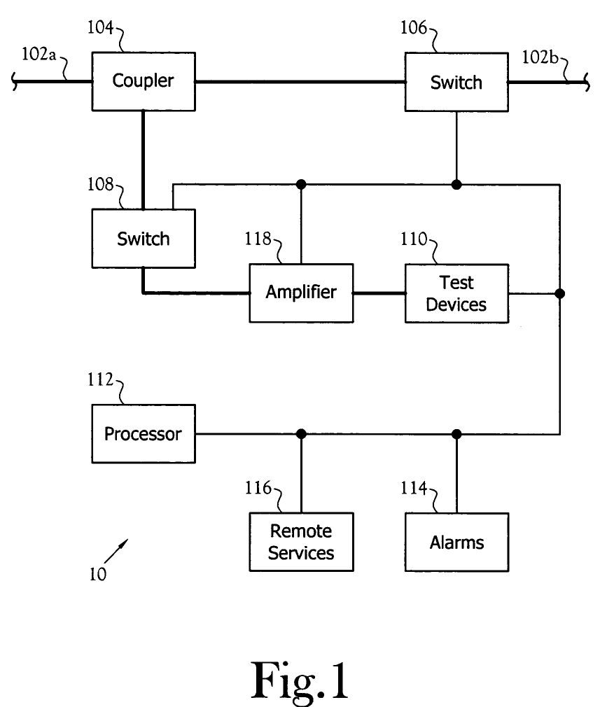

FIG. 1 illustrates a one-line diagram of the system 10 attached to an optical network 102, which is illustrated as having two sections identified as 102a, 102b with portions of the apparatus 10 between the two network sections 102a, 102b. In general, the apparatus 10 monitors the optical signals carried through an optical network 102, such as a synchronous optical network (SONET) or a synchronous digital hierarchy network (SDH), which includes a multitude of optical fiber pathways. A coupler 104, such as a planer wave guide circuit or fused biconic taper device, taps the optical network 102 and provides about 1 to 10% of the optical signal on the network. Placement of the coupler 104 in the optical network 102 is not critical. In one embodiment, the coupler 104 is placed before the receivers.

The coupler 104 taps into the network cables 102a adjacent a switch 106, which is controlled by a processor 112. The switch 106, in one embodiment, provides routing of the various optical signals on the network 102 based on various parameters monitored by the processor 112. The switch 106, in another embodiment, includes tunable filters, Bragg gratings or thin film filters for manipulating and routing discrete wavelengths among the various optical fiber cables forming the network 102. The switch 106, in still another embodiment, provides operational flexibility though the use of a combination of optical switches for protection, restoration, hot spare management, and bandwidth management.

The output optical signals from the coupler 104 are routed to a coupler switch, or coupler selector switch, 108, which routes the tapped optical signals through a receiver amplifier/attenuator 118 to various test devices 110. The coupler selector switch 108 is controlled by the processor 112 and the test devices 110 provide test result data to the processor 112. The amplifier 118 provides, in one embodiment, positive amplification, such as by a receiver amplifier, to boost the optical signal to the level required by specific test devices 110. In another embodiment, the amplifier 118 provides negative amplification, such as through a variable optical attenuator or other attenuator, to match the level required by specific test devices 110.

The processor 112 monitors the results of the test devices 110 and controls the switches 106, 108 and amplifier 118. The processor 112 also provides alarms 114 for out-of-specification optical performance and connects to remote services 116, such as remote terminals and other processors and systems. In various embodiments, the alarms 114 include an annunciator board, either through a computer display or a physical annunciator, showing the equipment being used to monitor the various channels, including the results and conformance or non-conformance, as well as a display showing any alarms by channel and function. The processor 112 includes software and routines for collecting, storing, characterizing, and profiling the results from the test devices 110. In addition, the processor 112 includes software and routines for controlling the optical switches 106, 108 to select and route optical channels. As used herein, the processor 112 should be broadly construed to mean any computer or component thereof that executes software.

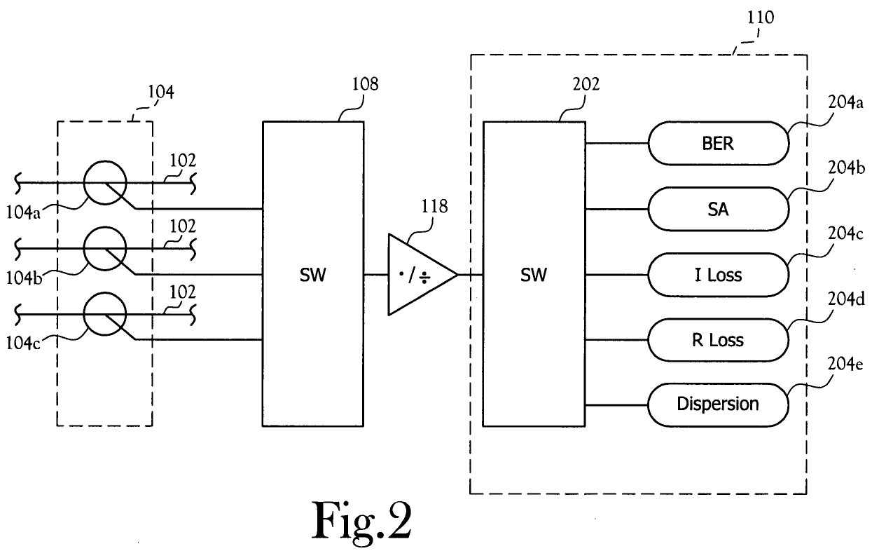

FIG. 2 illustrates the optical connections from the couplers 104, through the coupler selector switch 108, the receiver amplifier/attenuator 118, and into the test devices 110. The illustrated embodiment shows three couplers 104a, 104b, 104c that tap into the network cables 102. Those skilled in the art will recognize that the number of couplers 104 will vary with the number of optical cables 102 to be monitored. The tapped signals are input to a coupler selector switch 108, which selects one of the signals to route to the amplifier 118 and test devices 110. In one embodiment, the coupler selector switch 108 is an N×1 switch, that is, it has a selected number of inputs (N) that are switched to one output. In another embodiment in which the number of tapped signals exceeds the number of inputs to a single N×1 switch, the coupler selector switch 108 is a bank of N×1 switches connected to one or more N×1 switches.

The test devices 110 include a test switch 202, which in one embodiment is a 1×N switch, that switches the single optical signal to any one of the selected test equipment 204. In the illustrated embodiment, the test equipment 204 include monitoring of binary error rate (BER) 204a, spectrum analysis (SA) 204b, insertion loss (ILoss) 204c, return/reflectance loss (RLoss) 204d, and dispersion 204e. Those skilled in the art will recognize that the test equipment 204 can include any of a multitude of optical testing and monitoring equipment without departing from the spirit and scope of the present invention.

The amplifier 118 functions to increase or decrease the optical signal intensity to match the input signal requirements of each test equipment 204. In one embodiment, the optical signal strength is increased by a receiver amplifier. In another embodiment, the optical signal strength is decreased by an attenuator. In yet another embodiment, a variable attenuator adjusts the optical signal strength to the desired level. In still another embodiment, the amplifier 118 includes both a receiver amplifier and an attenuator to selectively adjust the optical signal strength.

In the illustrated embodiment, the amplifier 118 is located between the coupler switch 108 and the test switch 202. In another embodiment, each test device 204 has an amplifier 118 to match the optical signal strength to the particular test device 204.

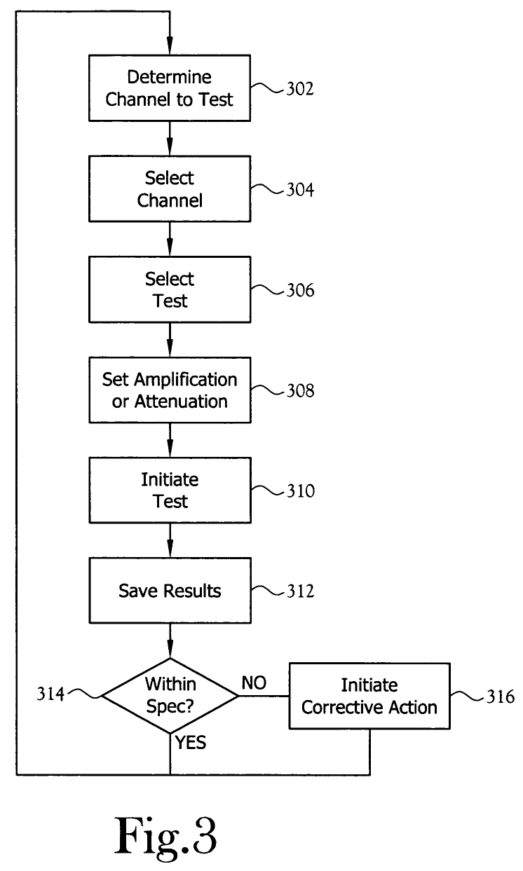

FIG. 3 illustrates one embodiment of the functions performed by the processor 112 with respect to testing. These functions are described as steps to be performed. The first step is to determine the channel to test 302. A channel represents an optical signal from a coupler 104. In one embodiment, a channel is an optical signal from a single optical cable 102. In another embodiment, a channel is a discrete wavelength from an optical cable 102 that contains one or more optical signals. In this embodiment, the discrete wavelength is separated from the others by a tunable filter, a Bragg grating, or a thin film filter after the coupler 104 and before the coupler selector switch 108. In one embodiment, the channels are sequentially selected for testing. In another embodiment, the channels are sequentially selected for testing, and channels that return marginal results or otherwise indicate that more frequent testing is desired, are tested more than once per sequential loop.

After determining the channel to test 302, the next step is to select the channel 304 to be tested. In one embodiment, selecting the channel 304 involves operating the coupler selection, or channel selection, switch 108, which is an N×1 switch, to select the channel for testing. In another embodiment, the number of channels is greater than can be switched by a single N×1 switch; therefore, the switch 108 includes an array of N×1 switches with the outputs of one bank of N×1 switches feeding the inputs to one or more N×1 switches.

After selecting the channel 304, the next step is to select the test 306. In one embodiment, the tests are selected sequentially. In another embodiment, the tests are selected sequentially, and channels that return marginal results for a particular test or otherwise indicate that more frequent testing is desired, have a test performed more frequently. In one embodiment, selecting the test 306 involves operating the switch 202, which is a 1×N switch, to select the test equipment 204 desired. In another embodiment, the number of test equipment 204 exceeds the number of outputs than can be switched by a single 1×N switch; therefore, the switch 202 includes an array of 1×N switches with the outputs of one 1×N switch feeding the inputs to a bank of 1×N switches.

After selecting the test 306, the next step is to set the amplification or attenuation 308 to match the input signal level to the signal level required by the test equipment 204. In one embodiment, setting the amplification or attenuation 308 is performed before switching the test equipment 204, which prevents an optical signal with an improper level from being seen by the test equipment 204. In one embodiment, setting the amplification or attenuation 308 is performed as illustrated in FIG. 2, that is, before the optical signal is passed through the coupler selector switch 202.

After the test signals are set up, the next step is to initiate the test 310. The test equipment 204 is computer controlled, that is, a processor 112 communicates with the test equipment 204 for both sending control signals, receiving status data, and receiving acquired test data. In one embodiment, the processor 112 communicates over a local area network. In another embodiment, the processor 112 communicates with the test equipment 204 over dedicated lines, such as serial or parallel cables. Those skilled in the art will recognize that the processor 112 can communicate with the test equipment 204 in any of various ways without departing from the spirit and scope of the present invention.

After the test is initiated 310, the next step is to save the results 312. In one embodiment, the results are saved 312 by the processor 112. In one embodiment, the processor 112 includes a memory storage component, such as a floppy disk, a hard disk, or a writable optical disc, onto which the test results are saved. In another embodiment, the processor 112 accesses an external memory storage unit onto which the test results are saved.

After the test results are collected by the processor 112, the test results are evaluated as to whether they are within specifications 314. The evaluation determines whether corrective action is required, and more specifically, depending upon the test being performed and the results of that test and previous tests, a specific corrective action may be warranted. In one embodiment, the test results are evaluated 314 after being saved 312. In another embodiment, the evaluation 314 occurs simultaneously with the saving of the test results 312. In one embodiment, the test results are evaluated 314 by comparing the test results to baseline data. In another embodiment, the test results are evaluated 314 by comparing the test results to threshold values. In one embodiment, the threshold values are preselected values. In another embodiment, the threshold values are based on previous test results and are adjusted based on trend data collected. In still another embodiment, the threshold values are based on the configuration of the system and the availability of spares.

If the test results are within specifications 314, the cycle repeats. That is, in the illustrated embodiment, the next channel to test is determined 302. In another embodiment, after one test is completed, the next test is selected 306. After all the tests are run, the next channel to test is determined 302.

If the test results are not within specifications 314, the next step is to initiate corrective action 316. The determination of the specific corrective action occurs during the evaluation of the results 314. The corrective action initiated 316 includes, in various embodiments, one or more of the following actions: a) send an alarm by a recorded telephone message to any of one or more telephone numbers, b) send an alarm through the network to any of a variety of alarms 114 and remote services 116, c) send a message to other systems or remote services 116 to request optical or layer two response to a failure or risk of failure, and/or d) optically reroute the channel in question, based on the type of test and how far the test results were out of specification. In one embodiment, optical rerouting of the channel is accomplished via the switch 106 on the optical network 102.

In various embodiments, the switch 106 includes one or more network healing smart switches, spare sources that can be switched into the network 104 and replace a failed or faulty channel, switches for rerouting fibers through other fibers, switches for rerouting through alternate wavelengths, and switches for rerouting traffic through channels shutdown because the channels were carrying lower guaranteed quality of service (QOS). In one embodiment, the switch 106 is a combination of various N×1, 1×N, and N×N optical switches that allow the switching to be performed at layer 1 of the optical network.

In one embodiment, each of the functions identified in FIG. 3 are performed by one or more software routines run by the processor 112. In another embodiment, one or more of the functions identified in FIG. 3 are performed by hardware and the remainder of the functions are performed by one or more software routines run by the processor 112. In still another embodiment, the functions are implemented with hardware, with the processor 112 providing routing and control of the entire integrated system 10. Those skilled in the art will recognize that it is possible to program a general-purpose computer or a specialized device to implement the invention.

The processor 112 executes software, or routines, for performing various functions. These routines can be discrete units of code or interrelated among themselves. Those skilled in the art will recognize that the various functions can be implemented as individual routines, or code snippets, or in various groupings without departing from the spirit and scope of the present invention. As used herein, software and routines are synonymous. However, in general, a routine refers to code that performs a specified function, whereas software is a more general term that may include more than one routines or perform more than one function.

The processor 112 should be broadly construed to mean any computer or component thereof that executes software. In one embodiment the processor 112 is a general purpose computer, in another embodiment, it is a specialized device for implementing the functions of the invention. Those skilled in the art will recognize that the processor 112 includes an input component, an output component, a storage component, and a processing component. The input component receives input from external devices, such as the test equipment 104 and remote services 116. The output component sends output to external devices, such as the coupler switch 108, the test device switch 202, alarms 114, and remote services 116. The storage component stores data and program code. In one embodiment, the storage component includes random access memory. In another embodiment, the storage component includes non-volatile memory, such as floppy disks, hard disks, and writeable optical disks. The processing component executes the instructions included in the software and routines.

The system for monitoring and testing an optical network includes various functions. The function of extracting a plurality of test signals from the optical network is implemented by the couplers 104 in the optical network 102. The function of selecting a channel for testing, with the channel being selected from said plurality of test signals, is implemented, in one embodiment, by software running on the processor 112 and the coupler switch 108. The function of selecting a test to perform on the selected channel is implemented, in one embodiment, by software running on the processor 112 and the coupler selector switch 202. The function of testing is implemented by the test equipment 204. In various embodiments, the test equipment includes one or more of a binary error rate test (BER) 204a, spectrum analysis (SA) 204b, insertion loss (ILoss) 204c, return/reflectance loss (RLoss) 204d, and dispersion 204e. The function of evaluating a test result is implemented, in one embodiment, by software running on the processor 112.

The function of performing corrective action is implemented, in one embodiment, by software running on the processor 112, which determines which corrective action to take. In various embodiments, the corrective action includes one or more of sending an alarm to a telephone, sending an alarm to an alarm unit 114, sending an alarm to a remote service 116, sending a message to the remote service 116 to request a response to a failure or risk of failure, and optically rerouting the channel in question via the network switch 106. The function of selectively modifying the intensity is performed by the processor 112 and the amplifier 118.

From the foregoing description, it will be recognized by those skilled in the art that a system for monitoring and managing optical networks has been provided. The system includes optical couplers, optical switches, test devices, and a processor.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

1. An apparatus for testing and monitoring an optical network, said apparatus comprising:
a plurality of couplers, each said coupler tapping into an optical fiber, each of said couplers representing a channel;
at least one coupler switch in communication with said plurality of couplers;
a test switch in communication with said at least one coupler switch;
a plurality of test equipment in communication with said test switch;
a processor in communication with said plurality of test equipment, said processor controlling said at least one coupler switch causing said at least one coupler switch to select one of said channels, said processor controlling said test switch causing said test switch to select one of said plurality of test equipment, said processor programmed to execute a process including selecting said channel to test, selecting one of said plurality of test equipment, initiating a test, saving a result of said test, and determining and initiating a corrective action; and
at least one routing switch in said optical network, said at least one routing switch in communication with said processor, said at least one routing switch for performing said corrective action.

2. The apparatus of claim 1 further including a device between said at least one coupler switch and said test switch, said device selectively modifying an intensity of an optical signal transmitted to said plurality of test equipment.

3. The apparatus of claim 1 wherein said corrective action is selected from a group including sending a first message to a telephone, sending a first alarm to an alarm unit, sending a second alarm to a remote service, sending a second message to a remote service to request a response to a failure or risk of failure, grooming the optical network, and optically rerouting said channel.

4. The apparatus of claim 1 wherein said at least one routing switch has a response time of less than or equal to 10 milliseconds.

5. An apparatus for testing and monitoring an optical network, said apparatus comprising:
a plurality of couplers, each said coupler tapping into an optical fiber, each said coupler representing a channel;
at least one coupler switch in communication with said plurality of couplers, said at least one coupler switch having one output selected from a plurality of inputs;
at least one test device in communication with said at least one coupler switch;
a processor in communication with said at least one test device, said processor controlling said at least one coupler switch causing said at least one coupler switch to select one of said channels, said processor programmed to execute a process including selecting said channel to test, initiating a test, and saving a result of said test.

6. The apparatus of claim 5 further including at least one routing switch in said optical network, said at least one routing switch in communication with said processor, and said at least one routing switch for routing a first optical channel to a second optical channel.

7. The apparatus of claim 5 further including a device between said at least one coupler switch and said at least one test device, said device selectively modifying an intensity of an optical signal transmitted to said at least one test device.

8. The apparatus of claim 7 wherein said processor controls said device to selectively modify said intensity.

9. The apparatus of claim 5 further including an optical amplifier between said at least one coupler switch and said at least one test device, said optical amplifier controlled by said processor.

10. The apparatus of claim 5 further including an attenuator between said at least one coupler switch and said at least one test device, said attenuator controlled by said processor.

11. The apparatus of claim 5 further including a test switch between said at least one coupler switch and said at least one test device wherein said at least one test device includes a plurality of test equipment, said test switch selecting one of said plurality of test equipment.

12. The apparatus of claim 11 wherein said plurality of test equipment includes at least one device selected from a group including binary error rate measurement, spectrum analysis, insertion loss, return/reflectance loss, optical time domain reflectometer, chromatic dispersion, polarization mode dispersion measurement, power, and reflection.

13. The apparatus of claim 5 wherein said processor includes determining and initiating a corrective action.

14. The apparatus of claim 13 wherein said corrective action is selected from a group including sending a first message to a telephone, sending a first alarm to an alarm unit, sending a second alarm to a remote service, sending a second message to a remote service to request a response to a failure or risk of failure, grooming the optical network, and optically rerouting said channel.

15. The apparatus of claim 5 wherein each of said at least one coupler switch is an N×1 switch, said N×1 switch having a number of inputs switchable to one output.

16. An apparatus for testing and monitoring an optical network, said apparatus comprising:
means for extracting a plurality of test signals from the optical network;
means for selecting a channel for testing, said channel being selected from said plurality of test signals;
means for testing said selected channel;
means for evaluating a test result; and
means for performing a corrective action.

17. The apparatus of claim 16 further including means for selectively modifying an intensity of said channel prior to testing said channel.

18. The apparatus of claim 16 further including means for selecting a test to perform on said selected channel;

19. At least one computer programmed to execute a process for monitoring and testing an optical network, the process comprising:
a) determining a channel to test, said channel representing an optical signal on the optical network;
b) selecting said channel to test by sending a control signal to a coupler switch, said coupler switch communicating with a plurality of couplers, each of said couplers connected to an optical cable forming the optical network.
c) initiating a test;
d) saving a result of said test;
e) comparing said result to at least one threshold;
f) determining if a corrective action is required; and
g) initiating said corrective action.

20. The process of claim 19 further including a step of setting an amplification level for said channel; said amplification level applied to said channel before said step of c) initiating said test.

21. The process of claim 19 further including a step of setting an attenuation level for said channel; said amplification level applied to said channel before said step of c) initiating said test.

22. The process of claim 19 wherein said step of a) determining said channel to test includes sequentially selecting each of said channels.

23. The process of claim 19 further including, after said step of e) comparing said result, flagging said channel for more frequent testing.

24. The process of claim 19 further including, before said step of c) initiating said test, selecting a test to perform on said channel.

25. The process of claim 24 wherein said step of selecting said test includes sequentially selecting each of a plurality of optical tests.

26. The process of claim 24 further including, after said step of e) comparing said result, flagging said test for more frequent testing.

27. The process of claim 19 wherein said test includes testing performed by at least one test equipment selected from a group including binary error rate measurement, spectrum analysis, insertion loss, return/reflectance loss, optical time domain reflectometer, chromatic dispersion, polarization mode dispersion measurement, power, and reflection.

28. The process of claim 19 wherein said corrective action is selected from a group including sending a first message to a telephone, sending a first alarm to an alarm unit, sending a second alarm to a remote service, sending a second message to a remote service to request a response to a failure or risk of failure, grooming the optical network, and optically rerouting said channel.

29. A computer system for monitoring and testing an optical network, said computer system comprising:
a processor including:
an input component receiving an input from at least one test device;
an output component sending an output to a coupler switch for selecting an optical channel to test;
a storage component saving said input from said at least one test device, said input representing a test result; and
a processing component executing a process including determining a selected channel for testing, selecting said channel, initiating said test, storing said test result, determining if corrective action is necessary, and initiating said corrective action.

30. The method of claim 29 wherein said output component communicates with a test switch for selecting one of a plurality of test equipment, and said process of said processing component includes selecting a test to perform.

31. The method of claim 29 wherein said output component communicates with an alarm unit for providing an indication of the optical network status.

32. The method of claim 29 wherein said output component communicates with a routing device for grooming and rerouting the optical network.

33. The method of claim 29 wherein said corrective action is selected from a group including sending a first message to a telephone, sending a first alarm to an alarm unit, sending a second alarm to a remote service, sending a second message to a remote service to request a response to a failure or risk of failure, grooming the optical network, and optically rerouting said channel.

34. Computer readable media tangibly embodying a program of instructions executable by a computer to perform a method of monitoring and testing an optical network, said method comprising:
a) determining a channel to test, said channel representing an optical signal on the optical network;
b) selecting said channel to test by sending a control signal to a coupler switch, said coupler switch communicating with a plurality of couplers, each of said couplers connected to an optical cable forming the optical network.
c) initiating a test;
d) saving a result of said test;
e) comparing said result to at least one threshold;
f) determining if a corrective action is required;
g) initiating said corrective action.

35. The method of claim 34 further including a step of setting an amplification level for said channel to be tested, said amplification level applied to said channel before said step of c) initiating said test.

36. The method of claim 34 further including setting an attenuation level for said channel to be tested, said attenuation level applied to said channel before said step of c) initiating said test.

37. The method of claim 34 wherein said step of a) determining said channel to test includes sequentially selecting each of said channels.

38. The method of claim 34 further including, after said step of e) comparing said result, flagging said channel for more frequent testing.

39. The method of claim 34 further including, before said step of c) initiating said test, a step of selecting said test to perform on said channel.

40. The method of claim 39 wherein said step of selecting said test includes sequentially selecting each of a plurality of optical tests.

41. The method of claim 39 further including, after said step of e) comparing said result, flagging said test for more frequent testing.

42. The method of claim 34 wherein said test includes testing performed by at least one test equipment selected from a group including binary error rate measurement, spectrum analysis, insertion loss, return/reflectance loss, optical time domain reflectometer, chromatic dispersion, polarization mode dispersion measurement, power, and reflection.

43. The method of claim 34 wherein said corrective action is selected from a group including sending a first message to a telephone, sending a first alarm to an alarm unit, sending a second alarm to a remote service, sending a second message to a remote service to request a response to a failure or risk of failure, grooming the optical network, and optically rerouting said channel.
